(19) United States
(12) Patent Application Publication
(10) Pub. No.: US 2017/0180904 A1
(43) Pub. Date: Jun. 22, 2017

(54) METHOD FOR USING A MOBILE DEVICE EQUIPPED WITH AT LEAST TWO MICROPHONES FOR DETERMINING THE DIRECTION OF LOUDSPEAKERS IN A SETUP OF A SURROUND SOUND SYSTEM

(71) Applicant: THOMSON LICENSING, Issy les Moulineaux (FR)

(72) Inventors: Michael ARNOLD, Isernhagen (DE); Michael DREXLER, Gehrden (DE); Florian KEILER, HANNOVER (DE)

(21) Appl. No.: 15/379,633

(22) Filed: Dec. 15, 2016

(30) Foreign Application Priority Data
Dec. 18, 2015 (EP) 15307064.4

(51) Int. Cl. H04S 7/00; H04R 29/00; H04R 1/40; H04R 5/02; H04R 5/04

(52) U.S. Cl. CPC H04S 7/301; H04R 5/02; H04R 5/04; H04R 1/406; H04R 29/002; H04R 2499/11

(57) ABSTRACT

A smartphone having two microphones is used for determining the direction of a loudspeaker in a surround system setup. This is performed using smartphone rotation in azimuth and polar angle direction while capturing in its microphones a test signal from a current one of the loudspeakers. From the microphone signals a corresponding TDOA value is calculated, and the smartphone is rotated until that TDOA value is nearly zero, resulting in a loudspeaker direction information.

### REFERENCE TO RELATED EUROPEAN APPLICATION

This application claims priority from European No. 15307064.4, entitled “Method For Using A Mobile Device Equipped With At Least Two Microphones for Determining The Direction Of Loudspeakers In A Setup Of A Surround Sound System,” filed on Dec. 18, 2015, the contents of which are hereby incorporated by reference in its entirety.

### TECHNICAL FIELD

The invention relates to a method for using a mobile device equipped with at least two microphones for determining the direction of loudspeakers lₖ in a setup of a surround sound system including N loudspeakers, k=1 . . . N .

### BACKGROUND

For 3D sound reproduction more and more loudspeakers are required for rendering additional audio channels that surround the listener. To ensure the best listener experience, this implicitly requires the correct determination of the direction as part of the position information of each loudspeaker, in order to accurately calibrate the array of speakers and to ensure a correct rendering process.

Currently different methods are available for determination of the direction of arrival, requiring the use of a multi-microphone device. This results in additional costs at user side.

### SUMMARY OF INVENTION

Today the number of smartphones equipped with more than one microphone (two or three) is increasing. A smartphone having at least two microphones is used for determining the direction of a loudspeaker in a surround system setup. The resulting effect is calibration equipment for home theatre setup that is today available in most households.

The advantages of using such mobile devices are:
cheap solution;
an improvement of the calibration setup can be achieved by updating an app;
by using more mobile devices including microphones, the measurement precision can be increased and the calibration time can be minimised.

A problem to be solved by the invention is to provide a cheap measurement of loudspeaker positions in a surround sound setup. This problem is solved by the method disclosed in claim 1 or in claim 2.

Advantageous additional embodiments of the invention are disclosed in the respective dependent claims.

In principle, the inventive method is adapted for using a mobile device equipped with at least two microphones for determining the direction of loudspeakers lₖ in a setup of a surround sound system including N loudspeakers, k=1 . . . N, wherein said direction is expressed by an azimuth angle φₖ and a polar angle θₖ, said method including:
a) setting initial values for said azimuth angle φₖ and said polar angle θₖ for loudspeaker lₖ direction;
b) in a first loop over mobile device position angle α for the determination of one of φₖ and θₖ, and thereafter in a second loop over mobile device position angle α for the determination of the other one of φₖ and θₖ:
c) setting k=1;
d) in a sub-loop over k:
e) in a sub-sub-loop over a rotation angle of said mobile device:
f) causing loudspeaker lₖ to emit a test signal;
g) rotating said mobile device and providing for said mobile device a corresponding measured mobile device rotation angle value αₖ;
h) capturing corresponding mobile device microphone signals from said loudspeaker lₖ test signal;
i) calculating from said microphone signals a corresponding TDOA value;
j) if said TDOA value is not zero or is not smaller than a predetermined thresh-old value, returning to step f);
k) otherwise, calculating a corresponding azimuth φₖ or polar θₖ, respectively, angle value for the position of loudspeaker lₖ;
l) incrementing k by ‘1’;
m) if k≦N, returning to step f);
n) otherwise, checking whether both of φₖ and θₖ have been determined, and if not true, returning to step b);
o) after all positions of said N loudspeakers have been determined, providing a corresponding set of N pairs of azimuth and polar angle values φₖ and θₖ for said loudspeakers lₖ and for all k.
   or
   for using a mobile device equipped with at least two microphones, having a known distance from each other, for determining the direction of loudspeakers lₖ in a setup of a surround sound system including N loudspeakers, k=1 . . . N, wherein said direction is expressed by an azimuth angle φₖ and a polar angle θₖ, said method including:
a) setting initial values for said azimuth angle φₖ and said polar angle θₖ for loudspeaker lₖ direction;
b) in a first loop over mobile device position angle α for the determination of one of φₖ and θₖ, and thereafter in a second loop over mobile device position angle α for the determination of the other one of φₖ and θₖ:
c) positioning said mobile device at a desired azimuth angle or polar angle;
d) setting k=1;
e) in a sub-loop over k:
f) causing loudspeaker lₖ to emit a test signal;
g) capturing the mobile device microphone signals from said loudspeaker lₖ test signal;
h) determining from said captured mobile device microphone signals a loudspeaker distance difference value and calculating a corresponding mobile device position angle value;
i) calculating a corresponding azimuth φₖ or polar θₖ, respectively, angle value for the position of loudspeaker lₖ;
j) incrementing k by ‘1’;
k) if k≦N, returning to step f);
l) otherwise, checking whether both of φₖ and θₖ have been determined, and if not true, returning to step b);
m) after all positions of said N loudspeakers have been determined, providing a corresponding set of N pairs of azimuth and polar angle values φₖ and θₖ for said loudspeakers lₖ and for all k.
   The disclosure further pertains first to a measurement device for determining the direction of loudspeakers lₖ in a setup of a surround sound system including N loudspeakers, k=1 . . . N, adapted to cooperate with a mobile device equipped with at least two microphones, wherein that direction is expressed by an azimuth angle φₖ and a polar angle θₖ. The mobile device comprises at least one processor configured for:
a) setting initial values for the azimuth angle φₖ and the polar angle θₖ for loudspeaker lₖ direction;
b) in a first loop over mobile device position angle α for the determination of one of φₖ and θₖ, and thereafter in a second loop over mobile device position angle α for the determination of the other one of φₖ and θₖ:
c) setting k=1;
d) in a sub-loop over k:
e) in a sub-sub-loop over a rotation angle of the mobile device:
f) receiving for the mobile device being rotated a corresponding measured mobile device rotation angle value αₖ;
g) receiving corresponding mobile device microphone signals from emitted loudspeaker lₖ test signal;
h) calculating from the microphone signals a corresponding TDOA value;
i) if the TDOA value is not zero or is not smaller than a predetermined threshold value, returning to step f);
j) otherwise, calculating a corresponding azimuth φₖ or polar θₖ, respectively, angle value for the position of loudspeaker lₖ;
k) incrementing k by ‘1’;
l) if k≦N, returning to step f);
m) otherwise, checking whether both of φₖ and θₖ have been determined, and if not true, returning to step b);
n) after all positions of the N loudspeakers have been determined, providing a corresponding set of N pairs of azimuth and polar angle values φₖ and θₖ for the loudspeakers lₖ and for all k.

In addition, the disclosure pertains secondly to a measurement device for determining ing the direction of loudspeakers lₖ in a setup of a surround sound system including ing N loudspeakers, k=1 . . . N, adapted to cooperate with a mobile device equipped with at least two microphones, wherein that direction is expressed by an azimuth angle φₖ and a polar angle θₖ. The mobile device comprises at least one processor configured for:
a) setting initial values for the azimuth angle φₖ and the polar angle θₖ for loudspeaker lₖ direction;
b) in a first loop over mobile device position angle α for the determination of one of φₖ and θₖ, and thereafter in a second loop over mobile device position angle α for the determination of the other one of φₖ and θₖ, the mobile device having a desired azimuth angle or polar angle:
c) setting k=1;
d) in a sub-loop over k:
e) receiving mobile device microphone signals from emitted loudspeaker lₖ test signal;
f) determining from said captured mobile device microphone signals a loudspeaker distance difference value and calculating a corresponding mobile device position angle value;
g) calculating a corresponding azimuth φₖ or polar θₖ, respectively, angle value for the position of loudspeaker lₖ;
h) incrementing k by ‘1’;
i) if k≦N, returning to step e);
j) otherwise, checking whether both of φₖ and θₖ have been determined, and if not true, returning to step b);
k) after all positions of the N loudspeakers have been determined, providing a corresponding set of N pairs of azimuth and polar angle values φₖ and θₖ for the loudspeakers lₖ and for all k.

Advantageously, the at least one processor is further configured for:
a) capturing mobile device microphone signals from loudspeaker lₖ test signal emitted by a selected loudspeaker lₖ among the N loudspeakers;
b) receiving for the mobile device a measured mobile device rotation angle value αₖ corresponding to a rotation of the mobile device;
c) calculating a corresponding TDOA value;
d) if said TDOA value is not zero or is not smaller than a predetermined threshold value, returning to step a);
e) otherwise, defining an initial direction angle value β=0;
f) receiving for the mobile device a measured rotation angle value β corresponding to rotating the mobile device by an angle β≈π/4;
g) receiving mobile device microphone signals from emitted loudspeaker lₖ test signal;
h) calculating from the mobile device microphone signals a loudspeaker distance difference value Δₖ and a microphone distance value

$${d}_{12} = \frac{{Δ}_{k}}{sin β} .$$

### BRIEF DESCRIPTION OF DRAWINGS

Exemplary embodiments of the invention are described with reference to the accompanying drawings, which show in:

FIG. 1 spherical coordinate system;

FIG. 2 different time of flight (ToF) for two microphones;

FIG. 3 equal time of flight after re-orientation of microphone pair;

FIG. 4 rotation of microphone pair by angle αₖ and corresponding (θₖ, φₖ),

$${φ}_{k} = {α}_{k} + \frac{π}{2}$$

measured x/y-plane;

FIG. 5 rotation of microphone pair by angle αₖ and corresponding (θₖ, φₖ), θₖ=αₖ measured from the z direction;

FIG. 6 assumption of far-away loudspeaker in relation to the microphone distance;

FIG. 7 ambiguity of loudspeaker location;

FIG. 8 interactive direction measurement for k ε1 , . . . , N loudspeakers;

FIG. 9 successive direction measurement for k ε1 , . . . , N loudspeakers;

FIG. 10 microphone distance calculation process.

### DESCRIPTION OF EMBODIMENTS

Even if not explicitly described, the following embodiments may be employed in any combination or sub-combination.

The correct calibration of a multi-channel audio system requires localisation of multiple speakers. This includes the determination of the direction and distance relative to the listener position. The distance can be measured as described in EP 2899997 A1or by optical means using the camera of a smartphone. The direction angles are determined by using an acoustical measurement as described below.

### Direction Angles

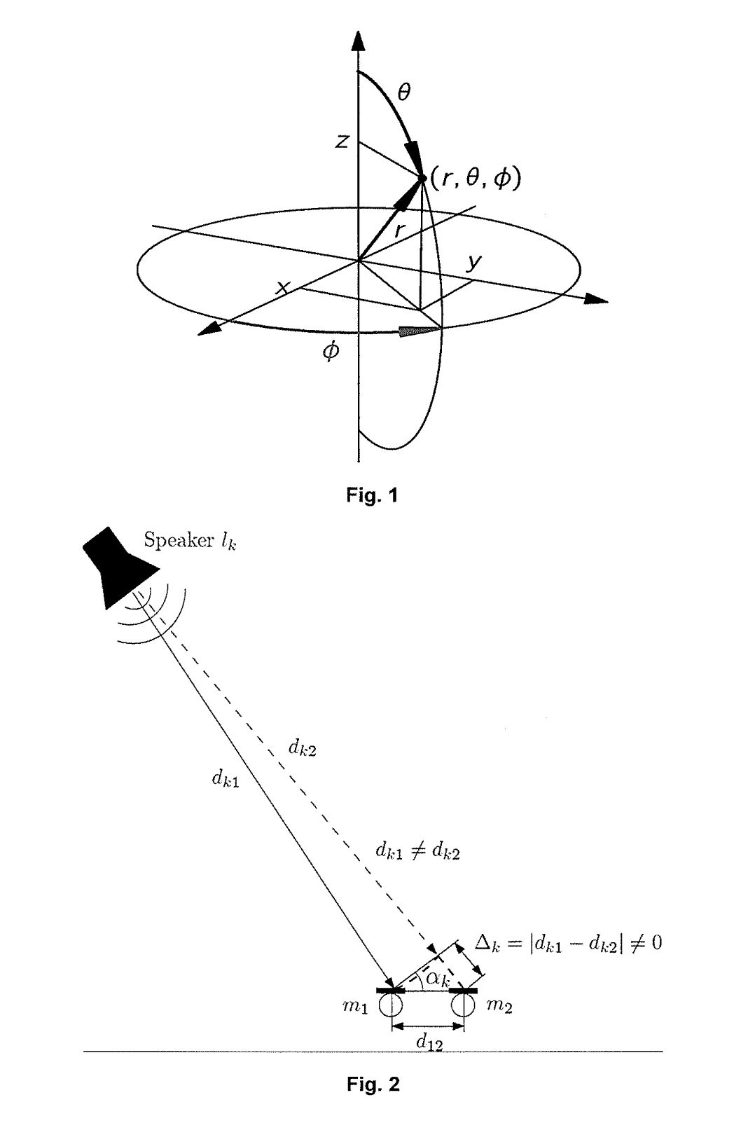

Assuming that the listener position is located in the coordinate origin of a three-dimensional coordinate system, the direction of each loudspeaker can be described by the azimuth angle φ and the polar angle θ in spherical coordinates (r, θ, φ), see FIG. 1.

The angles (θ, φ) can be determined in an interactive way by a device carrying two microphones, or by more devices each carrying one microphone.

### Sound Propagation

In the following a microphone pair (m₁, m₂) with known orientation and a speaker lₖ with unknown position are considered. If the speaker emits a signal sₖ(t), the signals captured by the microphones will be attenuated and altered by noise. The so-called Time of Flight (ToF) ΔTₖ₁ is the time the sound wave needs for propagating from the source (speaker lₖ) to the microphone m₁. Using a second microphone m₂ the ToF is ΔTₖ₂. The signals at the microphone positions are:

yₖ₁(t)=g(dₖ₁)sₖ(t−ΔTₖ₁)+n₁(t)

yₖ₂(t)=g(dₖ₂)sₖ(t−ΔTₖ₂)+n₂(t)

The function g(d_{k°}) is an attenuation factor, which describes the dependence of the amplitude on the distance between loudspeaker k and microphone 1 or 2 denoted by d_{k°}. The amplitudes and the phases of the two signals yₖ₁(t), yₖ₂(t) differ due to the relative positioning of the microphones to the source. The additive terms n₁(t) and n₂(t) take into account environmental and internal (thermal) noise of the microphones.

### Angle Determination

The angle measurements can be integrated in a calibration step of a 3D surround sound loudspeaker setup controlled by a smartphone. The determination of the angles are based on the measurement of the Time Difference of Arrival TDOA. The TDOA for loudspeaker lₖ for the microphone pair (1,2) is defined as τₖ=ΔTₖ₁−ΔTₖ₂. This corresponds to the spatial difference Δₖ=|dₖ₁−dₖ₂|=C|τₖ| between the two microphones and the loudspeaker with the sound velocity in air as the scaling factor, see FIG. 2. c is the speed of sound waves in the air.

### TDOA Measurement

It is known to estimate the TDOA by using a cross-corre-lation (CC) function

Rₖ(τ)= [symbol] {yₖ₁(t)yₖ₂(t−τ)}=∫^{+∞}_{-∞}Yₖ₁(f)Y*ₖ₂(f)exp^{2πifτ}df

with y_{k(1|2)}(t) being the signals captured by the microphones (m₁ or m₂ for speaker k) and Y_{k(1|2)}(f) being their respective Fourier transforms. The time delay between the captured signals is obtained by searching the peak in the correlation

$${τ}_{k} = arg {max}_{τ} {R}_{k} ( τ ) .$$

Known techniques for providing a sharper peak in the measurement and using interpolation for a higher time resolution can be applied.

### Calibration Process—Interactive Angle Measurement

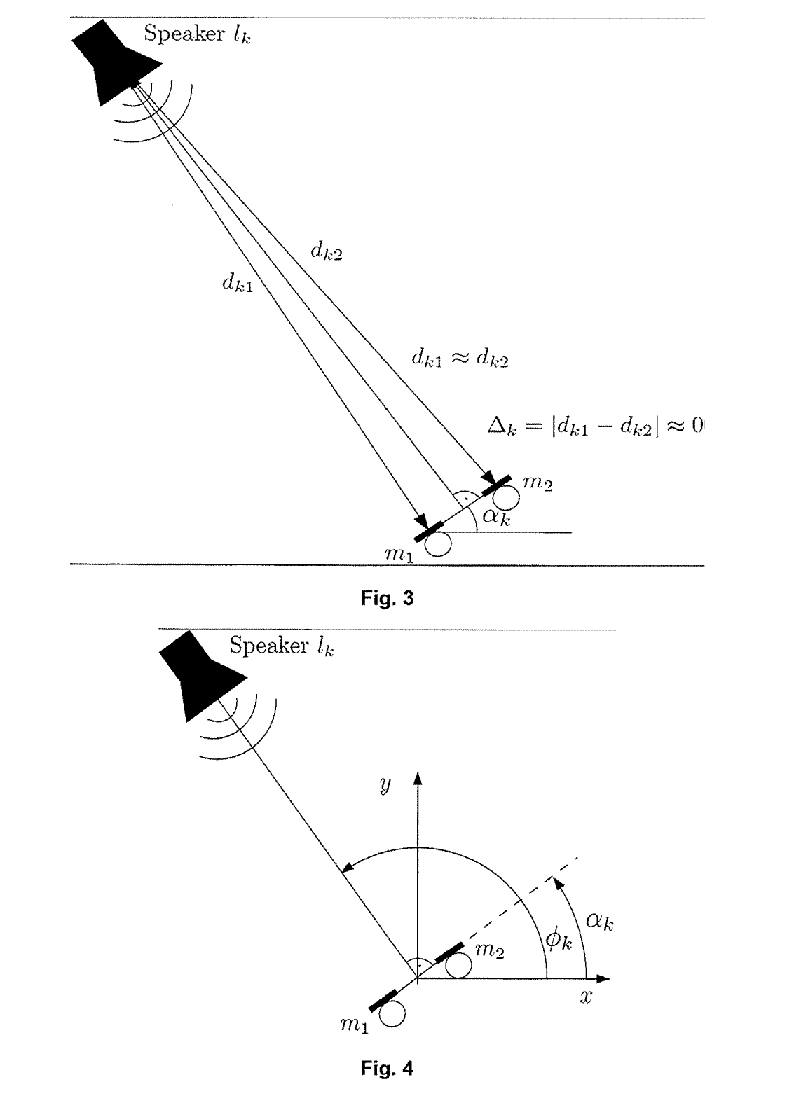

In an interactive measurement a smartphone carrying a pair of microphones is used for the direction determination. It is not necessary that the distance d₁₂ (see FIG. 2) between the microphone pair (m₁, m₂) is known. If the ToF needed for the sound wave to propagate from the source to the first microphone is the same as for the second microphone as is depicted in FIG. 3, the TDOA is zero.

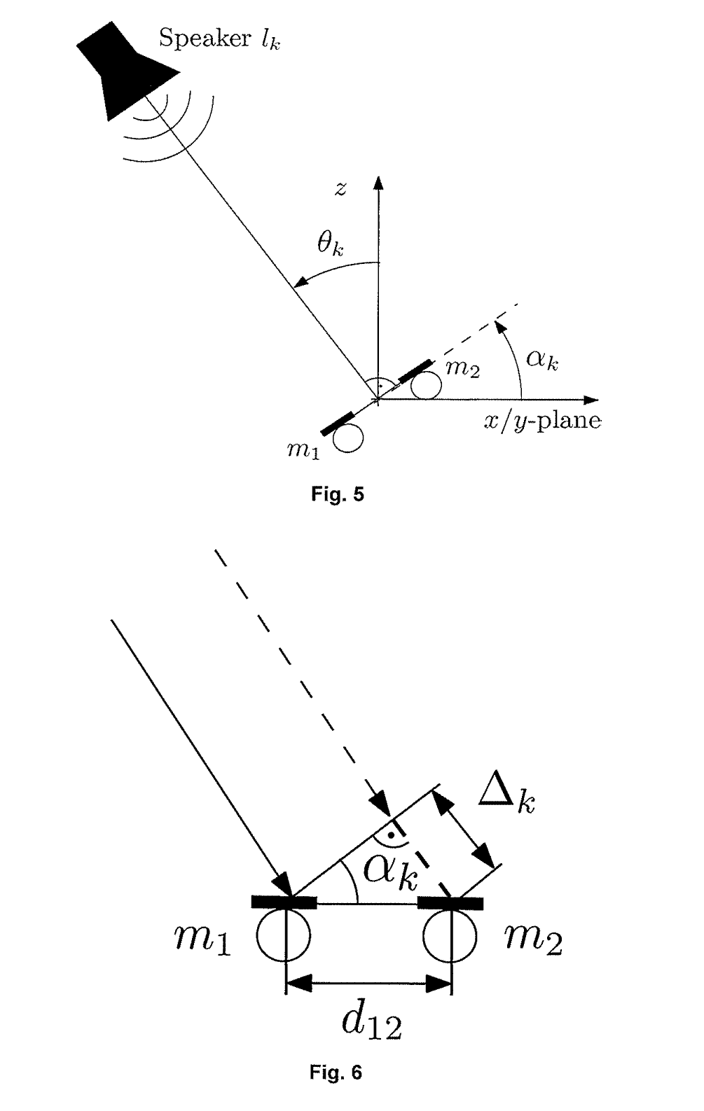

The angles φₖ and θₖ are defined relative to the baseline connecting the two microphones (see FIGS. 4 and 5). In a first step a reference direction is defined from which the angles are measured. For determination of the θₖ angle, the microphone pair can be placed in the x/y-plane using the z-axis as reference direction (see FIG. 5).

During playback of the signal from the loudspeaker, the user is moving the smartphone in the direction of the loudspeaker. In this case the TDOA can be continuously measured. This implies an ongoing transmission and capturing of the calibration signal. The device carried by the user can provide a graphical feedback like a level meter which increases if the TDOA is converging to zero. As an alternative, a special sound can be played back if TDOA for the microphones is converging to zero.

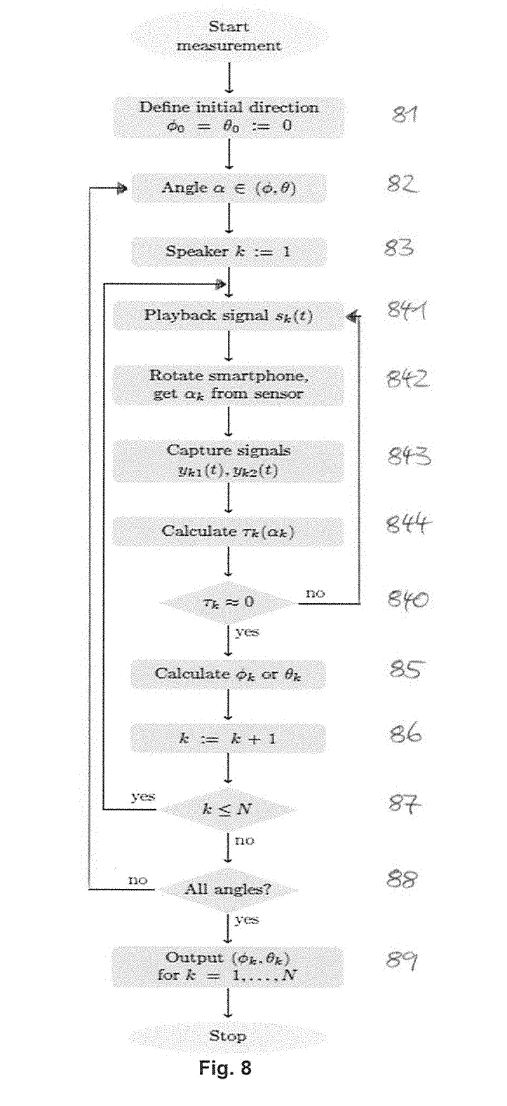

In an automatic setting the time delay is measured continuously and the angles yielding the minimal time delay are computed as shown in the FIG. 8 flow chart. The angle measurement is carried out by using corresponding data from the internal sensors of the smartphone.

In step 81, initial values φ₀ and θ₀ for the azimuth angle φₖ and the polar angle θₖ are defined, e.g. φ₀=θ₀=0.The processing is continued from step 82 to step 88 with a first loop over angle αfor the determination of one of φₖ and θₖ, e.g . φₖ. Thereafter that loop over angle αis again carried out for the determination of the other one of φₖ and θₖ, e.g. θₖ. In step 89 φₖ and θₖ, k=1 . . . N, for all N loudspeaker positions are output.

In step 83 k=1 is set, and within the following sub-loop over k from step 841 to step 87 k is incremented in step 86 until k>N in step 87.

In a sub-sub-loop beginning in step 841, loudspeaker lₖ emits a test signal sₖ(t). In step 842 the smartphone is rotated by a recommended angle, e.g. 45° or 90°, and the corresponding true smartphone rotation angle αₖ is provided from the related sensors within the smartphone. Then the smartphone microphones capture signals yₖ₁(t) and yₖ₂(t) in step 843, and in step 844 τₖ(αₖ) is calculated as described above. By testing step 840 the processing is continued with step 841 for a different smartphone rotation angle, until in step 840 τₖ=0 or nearly zero, i.e. until the value τₖ is smaller than a predetermined threshold value. If true, in step 85 the corresponding φₖ or θₖ, respectively, value is calculated as described above.

### Calibration Process—Successive Angle Measurement

In case the distance d₁₂ (see FIG. 2) between the microphone pair (m₁, m₂) is known, e.g. from information taken from a corresponding database, as an alternative to interactive rotation of the smartphone with respect to each loudspeaker for direction determination, another processing can be applied. It can be assumed that the distances dₖ₁,dₖ₂ between the mobile device and the loudspeakers are much greater than the distance d₁₂ between the microphones, i.e. dₖ₁>>d₁₂. In that case the right-angled triangle in FIG. 6 can be used for the direction computation of N loudspeakers according to smart phone position angle

$${α}_{k} = arcsin ( \frac{{Δ}_{k}}{{d}_{12}} ) ,$$

k=1, . . . , N .

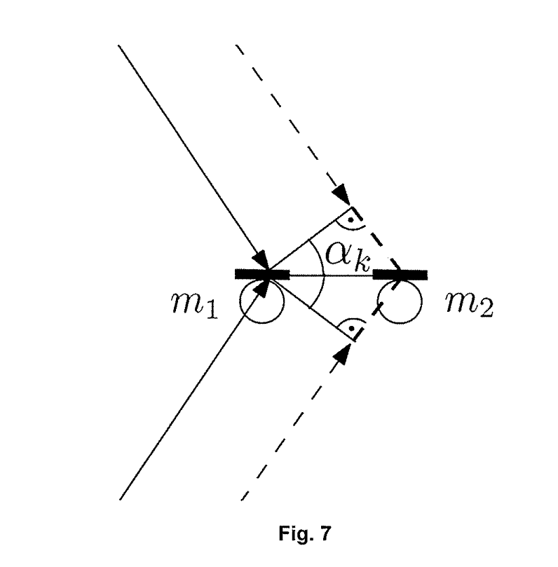

To avoid the ambiguity about in which half space a loudspeaker is located (see FIG. 7), two successive measurements can be conducted. In the second measurement the device can be rotated by 90°. In this case the determination of the sign of the time delay τₖ is sufficient for fixing the direction of the loudspeaker.

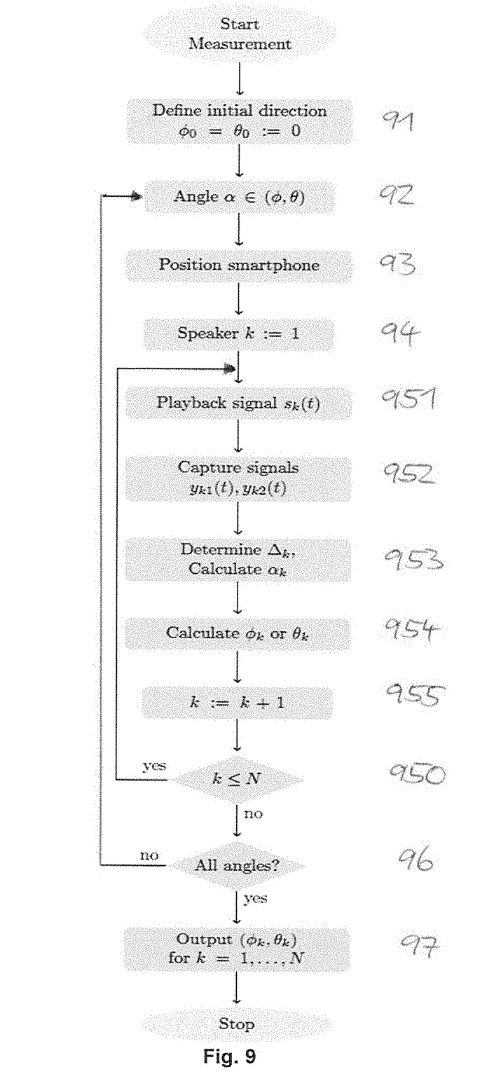

In a practical setting each measurement can be conducted for all loudspeakers before performing the next one, as depicted in the FIG. 9 flow chart.

In step 91, initial values φ₀ and θ₀ for the azimuth angle φₖ and the polar angle θₖ are defined, e.g . φ₀=θ₀=0. The processing is continued from step 92 to step 96 with a first loop over smart phone position angle αfor the determination of one of φₖ and θₖ, e.g . φₖ. Thereafter that loop over smart phone position angle α is again carried out for the determination of the other one of φₖ and θₖ, e.g. θₖ. In step 97 φₖ and θₖ, k=1 . . . N, for all N loudspeaker positions are output.

In step 93 the current position of the smartphone is determined from the internal sensors of the smartphone. In step 94 k=1 is set and, within the following sub-loop processing over k from step 951 to step 950, k is incremented in step 955 until k>N in step 950.

In step 951 loudspeaker lₖ emits a test signal sₖ(t). In step 952 the smartphone microphones are capturing signals yₖ₁(t) and yₖ₂(t). Also using d₁₂, in step 953 the loudspeaker distance difference value Δₖ and a corresponding smart phone position angle value αₖ are calculated therefrom as described above, and in step 954 the corresponding φₖ or θₖ, respectively, value is calculated as described above.

### Calibration Process—Determination of Microphone Distance

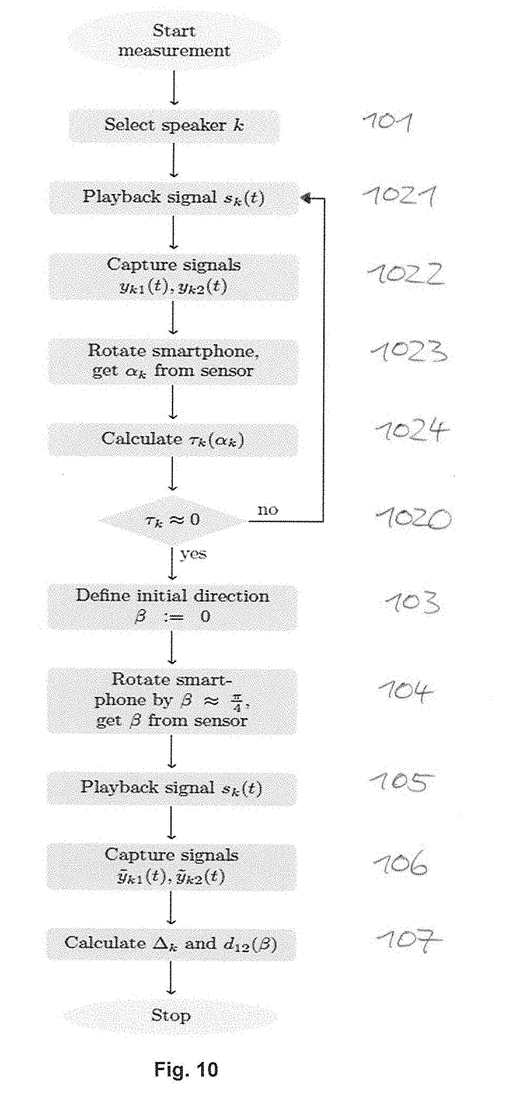

In order to conduct a successive measurement as described in the preceding section, a necessary precondition is knowledge of the smartphone microphone distance d₁₂. In case this distance is not known in advance it can be determined by an interactive measurement using one loudspeaker k. During the interactive measurement processing described in connection with FIG. 10, the smartphone is aligned in the direction of the loudspeaker as described in section Interactive angle measurement.

Starting from this reference position, the smartphone is rotated by a predefined angle

$$β < \frac{π}{2} .$$

In this position the loudspeaker distance difference Δₖ is measured and the microphone distance d₁₂ is calculated by

$${d}_{12} = \frac{{Δ}_{k}}{sin β} ,$$

cf. FIG. 6 and FIG. 10.

Microphone distance d₁₂ is then used in the direction determination of the remaining loudspeakers as described in section Successive angle measurement.

In FIG. 10 the calculation process for the microphone distance starts with selecting loudspeaker lₖ in step 101. In step 1021 that loudspeaker emits a test or playback signal sₖ(t) and the smartphone is rotated slowly and captures in step 1022 the signals yₖ₁(t) and yₖ₂(t). In step 1023 the current value of τₖ(αₖ) is calculated and in step 1020 it is checked whether the current value of τₖ is zero or nearly zero, i.e. is smaller than a predetermined threshold value. If not true, the processing continues with step 1021. If true, the smartphone has reached a desired reference position and the processing moves to step 103 in which an initial direction angle value β=0 is set. In step 104 the smartphone is rotated by β≈π/4 and the corresponding true rotation angle β is provided from the related sensors within the smartphone.

In step 105 loudspeaker lₖ again emits the test or playback signal sₖ(t). In step 106 the signals yₖ₁(t) and yₖ₂(t) are captured, and in step 107 the loudspeaker distance difference value Δₖ and the microphone distance value d₁₂(β) are calculated.

The described processing can be carried out by a single processor or electronic circuit, or by several processors or electronic circuits operating in parallel and/or operating on different parts of the complete processing.

The instructions for operating the processor or the processors according to the described processing can be stored in one or more memories. The at least one processor is configured to carry out these instructions.

1. Method for using a mobile device equipped with at least two microphones (m₁, m₂) for determining the direction of loudspeakers lₖ in a setup of a surround sound system including N loudspeakers, k=1 . . . N, wherein said direction is expressed by an azimuth angle φₖ and a polar angle θₖ, said method including:
a) setting initial values (φ₀, θ₀) for said azimuth φₖ and said polar angle θₖ for loudspeaker lₖ direction;
b) in a first loop over mobile device position angle α for the determination of one of φₖ and θₖ, and thereafter in a second loop over mobile device position angle α for the determination of the other one of φₖ and θₖ:
c) setting k=1;
d) in a sub-loop over k:
e) in a sub-sub-loop over a rotation angle of said mobile device:
f) causing loudspeaker lₖ to emit a test signal (sₖ(t)) ;
g) rotating said mobile device and providing for said mobile device a corresponding measured mobile device rotation angle value αₖ;
h) capturing corresponding mobile device microphone signals (yₖ₁(t), yₖ₂(t)) from said loudspeaker lₖ test signal;
i) calculating from said microphone signals a corresponding TDOA value (τₖ(αₖ));
j) if said TDOA value (τₖ(αₖ)) is not zero or is not smaller than a predetermined threshold value, returning to step f);
k) otherwise, calculating a corresponding azimuth φₖ or polar θₖ, respectively, angle value for the position of loudspeaker lₖ;
l) incrementing k by ‘1’;
m) if k≦N, returning to step f);
n) otherwise, checking whether both of φₖ and θₖ have been determined, and if not true, returning to step b);
o) after all positions of said N loudspeakers have been determined, providing a corresponding set of N pairs of azimuth and polar angle values φₖ and θₖ for said loudspeakers lₖ and for all k.

2. Method for using a mobile device equipped with at least two microphones (m₁, m₂) having a known distance (d₁₂) from each other, for determining the direction of loudspeakers lₖ in a setup of a surround sound system including N loudspeakers, k=1 . . . N, wherein said direction is expressed by an azimuth angle φₖ and a polar angle θₖ, said method including:
a) setting initial values (φ₀, θ₀) for said azimuth angle φₖ and said polar angle θₖ for loudspeaker lₖ direction;
b) in a first loop over mobile device position angle α for the determination of one of φₖ and θₖ, and thereafter in a second loop over mobile device position angle αfor the determination of the other one of φₖ and θₖ:
c) positioning said mobile device at a desired azimuth angle or polar angle;
d) setting k=1;
e) in a sub-loop over k:
f) causing loudspeaker lₖ to emit a test signal (sₖ(t)) ;
g) capturing the mobile device microphone signals (yₖ₁(t), yₖ₂(t)) from said loudspeaker lₖ test signal;
h) determining from said captured mobile device microphone signals (ykl(t), yₖ₂(t)) a loudspeaker distance difference value (Δₖ) and calculating a corresponding mobile device position angle value (αₖ);
i) calculating a corresponding azimuth φₖ or polar θₖ, respectively, angle value for the position of loudspeaker lₖ;
j) incrementing k by ‘1’;
k) if k≦N, returning to step f);
l) otherwise, checking whether both of φₖ and θₖ have been determined, and if not true, returning to step b);
m) after all positions of said N loudspeakers have been determined, providing a corresponding set of N pairs of azimuth and polar angle values φₖ and θₖ for said loudspeakers lₖ and for all k.

3. Method according to claim 2, wherein for determining the distance (d₁₂) between said two microphones (m₁, m₂) the following processing is carried out:
a) selecting one loudspeaker lₖ of said N loudspeakers;
b) causing loudspeaker lₖ to emit a test signal (sₖ(t)) ;
c) capturing the mobile device microphone signals (yₖ₁(t), yₖ₂(t)) from said loudspeaker lₖ test signal;
d) rotating said mobile device and providing for said mobile device a corresponding measured mobile device rotation angle value αₖ;
e) calculating a corresponding TDOA value (τₖ(αₖ));
f) if said TDOA value (τₖ(αₖ)) is not zero or is not smaller than a predetermined threshold value, returning to step b);
g) otherwise, defining an initial direction angle value β=0;
h) rotating said mobile device by an angle β≈π/4 and providing for said mobile device a corresponding measured rotation angle value β;
i) causing loudspeaker lₖ to emit a test signal (sₖ(t)) ;
j) capturing the mobile device microphone signals (y_{yk}(t), yₖ₂(t)) from said loudspeaker lₖ test signal;
k) calculating from said mobile device microphone signals (yₖ₁(t), yₖ₂(t)) a loudspeaker distance difference value Δₖ and a microphone distance value
$${d}_{12} = \frac{{Δ}_{k}}{sin β} .$$

4. Method according to claim 1, wherein said mobile device is a smartphone including an app that controls the processing.

5. Method according to claim 2, wherein said mobile device is a smartphone including an app that controls the processing.

6. Method according to claim 1, wherein said mobile device microphone signals are
yₖ₁(t)=g(dₖ₁)sₖ(t−ΔTₖ₁)+n₁(t)
and
yₖ₂(t)=g(dₖ₂)sₖ(t−ΔTₖ₂)+n₂(t),
wherein ΔTₖ₁ is the time the sound wave needs for propagating from loudspeaker lₖ to microphone m₁ and ΔTₖ₂ is the time the sound wave needs for propagating from loudspeaker lₖ to microphone m₂, sₖ(°) is said test signal, g(d_{k°}) is an attenuation factor which describes the dependence of the amplitude on the distance d_{k°} between loudspeaker lₖ and microphone m₁ or m₂, and n₁(t) and n₂(t) take into account environmental and internal noise of said microphones.

7. Method according to claim 2, wherein said mobile device microphone signals are
yₖ₁(t)=g(dₖ₁)sₖ(t−ΔTₖ₁)+n₁(t)
and
yₖ₂(t)=g(dₖ₂)sₖ(t−ΔTₖ₂)+n₂(t),
wherein ΔTₖ₁ is the time the sound wave needs for propagating from loudspeaker lₖ to microphone m₁ and ΔTₖ₂ is the time the sound wave needs for propagating from loudspeaker lₖ to microphone m₂, sₖ(°) is said test signal, g(d_{k°}) is an attenuation factor which describes the dependence of the amplitude on the distance d_{k°}between loudspeaker lₖ and microphone m₁ or m₂, and n₁(t) and n₂(t) take into account environmental and internal noise of said microphones.

8. Method according to claim 6, wherein said TDOA for loudspeaker lₖ for said mobile device microphones is defined as τₖ=ΔTₖ₁−ΔTₖ₂, which corresponds to the spatial difference Δₖ=|dₖ₁−dₖ₂|=c|τₖ| between said mobile device microphones and said loudspeaker lₖ with the sound velocity c in air as a scaling factor.

9. Method according to claim 7, wherein said TDOA for loudspeaker lₖ for said mobile device microphones is defined as τₖ=ΔTₖ₁−ΔTₖ₂, which corresponds to the spatial difference Δₖ=|dₖ₁−dₖ₂|=c|τₖ| between said mobile device microphones and said loudspeaker lₖ with the sound velocity c in air as a scaling factor.

10. Method according to claim 1, wherein said TDOA is estimated by using a cross-correlation function
Rₖ(τ)= [symbol] {yₖ₁(t)yₖ₂(t−τ)}=∫^{+∞}_{-∞}Yₖ₁(f)Y*ₖ₂(f)exp^{2πifτ}df
with y_{k(1|2)}(t) being the signals captured by said mobile device microphones and Y_{k(1|2)}(f) being their respective Fourier transforms, and wherein the time delay between the microphone signals is obtained by searching the peak in the correlation
$${τ}_{k} = arg {max}_{τ} {R}_{k} ( τ ) .$$

11. Method according to claim 2, wherein said TDOA is estimated by using a cross-correlation function
Rₖ(τ)= [symbol] {yₖ₁(t)yₖ₂(t−τ)}=∫^{+∞}_{-∞}Yₖ₁(f)Y*ₖ₂(f)exp^{2πifτ}df
with y_{k(1|2)}(t) being the signals captured by said mobile device microphones and Y_{k(1|2)}(f) being their respective Fourier transforms, and wherein the time delay between the microphone signals is obtained by searching the peak in the correlation
$${τ}_{k} = arg {max}_{τ} {R}_{k} ( τ ) .$$

12. Method according to claim 1, wherein, instead of interactive rotation of said mobile device with respect to each loudspeaker for direction determination, it is assumed that the distances dₖ₁, dₖ₂ between the microphones of said mobile device and said loudspeaker are much greater than the distance d₁₂ between the microphones in said mobile device, and the angle αₖ between the line between both microphones and the direction of said loudspeaker is
$${α}_{k} = arcsin ( \frac{{Δ}_{k}}{{d}_{12}} ) ,$$
k=1, . . . N, and wherein, in order to avoid the ambiguity about in which half space a loudspeaker is located, two successive measurements are conducted and in the second measurement said mobile device is rotated by approximately 90° and the determination of the sign of said time delay τₖ is used for fixing the direction of said loudspeaker.

13. Computer program product comprising instructions which, when carried out on a computer or mobile device, perform the method according to claim 1.

14. Computer program product comprising instructions which, when carried out on a computer or mobile device, perform the method according to claim 2.

15. A measurement device for determining the direction of loudspeakers lₖ in a setup of a surround sound system including N loudspeakers, k=1 . . . N, adapted to cooperate with a mobile device equipped with at least two microphones (m₁, m₂), wherein said direction is expressed by an azimuth angle φₖ and a polar angle θₖ, said mobile device comprising at least one processor configured for:
a) setting initial values (φ₀, θ₀) for said azimuth angle φₖ and said polar angle θₖ for loudspeaker lₖ direction;
b) in a first loop over mobile device position angle α for the determination of one of φₖ and θₖ, and thereafter in a second loop over mobile device position angle α for the determination of the other one of φₖ and θₖ:
c) setting k=1;
d) in a sub-loop over k:
e) in a sub-sub-loop over a rotation angle of said mobile device:
f) receiving for said mobile device being rotated a corresponding measured mobile device rotation angle value τₖ;
g) receiving corresponding mobile device microphone signals (yₖ₁(t), yₖ₂(t)) from emitted loudspeaker lₖ test signal;
h) calculating from said microphone signals a corresponding TDOA value (τₖ(αₖ)) ;
i) if said TDOA value (τₖ(αₖ)) is not zero or is not smaller than a predetermined threshold value, returning to step f);
j) otherwise, calculating a corresponding azimuth φₖ or polar θₖ, respectively, angle value for the position of loudspeaker lₖ;
k) incrementing k by ‘1’;
l) if k≦N, returning to step f);
m) otherwise, checking whether both of φₖ and θₖ have been determined, and if not true, returning to step b);
n) after all positions of said N loudspeakers have been determined, providing a corresponding set of N pairs of azimuth and polar angle values φₖ and θₖ for said loudspeakers lₖ and for all k.

16. A measurement device for determining the direction of loudspeakers lₖ in a setup of a surround sound system including N loudspeakers, k=1 . . . N, adapted to cooperate with a mobile device equipped with at least two microphones (m₁, m₂), wherein said direction is expressed by an azimuth angle φₖ and a polar angle θₖ, said mobile device comprising at least one processor configured for:
a) setting initial values (φ₀, θ₀) for said azimuth angle φₖ and said polar angle θₖ for loudspeaker lₖ direction;
b) in a first loop over mobile device position angle α for the determination of one of φₖ and θₖ, and thereafter in a second loop over mobile device position angle α for the determination of the other one of φₖ and θₖ, said mobile device having a desired azimuth angle or polar angle:
c) setting k=1;
d) in a sub-loop over k:
e) receiving mobile device microphone signals (yₖ₁(t), yₖ₂(t)) from emitted loudspeaker lₖ test signal (sₖ(t));
f) determining from said captured mobile device microphone signals (yₖ₁(t), yₖ₂(t)) a loudspeaker distance difference value (Δₖ) and calculating a corresponding mobile device position angle value (αₖ) ;
g) calculating a corresponding azimuth φₖ or polar θₖ, respectively, angle value for the position of loudspeaker lₖ;
h) incrementing k by ‘1’;
i) if k≦N , returning to step e);
j) otherwise, checking whether both of φₖ and θₖ have been determined, and if not true, returning to step b);
k) after all positions of said N loudspeakers have been determined, providing a corresponding set of N pairs of azimuth and polar angle values φₖ and θₖ for said loudspeakers lₖ and for all k.

17. The measurement device of claim 16, in which said at least one processor is further configured for:
a) capturing mobile device microphone signals (yₖ₁(t), Yₖ₂(t)) from loudspeaker lₖ test signal emitted by a selected loudspeaker lₖ among said N loudspeakers;
b) receiving for said mobile device a measured mobile device rotation angle value αₖ corresponding to a rotation of said mobile device;
c) calculating a corresponding TDOA value (τₖ(αₖ));
d) if said TDOA value (τₖ(αₖ)) is not zero or is not smaller than a predetermined threshold value, returning to step a);
e) otherwise, defining an initial direction angle value β=0;
f) receiving for said mobile device a measured rotation angle value β corresponding to rotating said mobile device by an angle β≈π/4;
g) receiving mobile device microphone signals from emitted loudspeaker lₖ test signal;
h) calculating from said mobile device microphone signals a loudspeaker distance difference value Δₖ and a microphone distance value
$${d}_{12} = \frac{{Δ}_{k}}{sin β} .$$
